(19) United States
(12) Patent Application Publication
(10) Pub. No.: US 2005/0188246 A1
(43) Pub. Date: Aug. 25, 2005

(54) Persistent worldwide names assigned to removable media storage

(76) Inventors: Robert George Emberty, Tucson, AZ (US); Nils Haustein, Zornheim, NH (US); Craig Anthony Klein, Tucson, AZ (US); Daniel James Winarski, Tucson, AZ (US)

Correspondence Address: INTERNATIONAL BUSINESS MACHINES CORPORATION, 9000 SOUTH RITA ROAD, TUCSON, AZ, 85744, US

(21) Appl. No.: 10/786,263

(22) Filed: Feb. 25, 2004

(51) Int. Cl. G06F 12/16

(52) U.S. Cl. 714/5; 711/162; 711/115; 711/114

(57) ABSTRACT

Disclosed are a system, a method, and article of manufacture to provide for managing removable storage media that is identified by a persistent worldwide name. SAN storage management is enhanced by preserving the persistent worldwide names assigned to removable storage media when it is necessary to replace the removable storage media. Exemplary embodiments include determining that a first removable storage media identified by a persistent worldwide name needs to be replaced, creating a copy of the data from the first removable storage media and assigning the persistent worldwide name to the second removable storage media.

### TECHNICAL FIELD

The present invention relates generally to network devices in a storage system implementing unique names for enabling communication with the devices. More particularly, the invention relates to a novel system and method for managing the replacement of removable storage media that are identified by persistent worldwide names.

### BACKGROUND OF THE INVENTION

A common host communication interface for open systems storage products is Fibre Channel-Arbitrated Loop (FC-AL) which can be used to connect large amounts of storage to a server or cluster of servers. A Fibre Channel-Arbitrated Loop (FC-AL) disk and tape drive interface particularly enables implementation of new applications that need high-speed data storage over long distances. These emerging applications include professional movie editing, collaborative engineering efforts, video-on-demand, medical imaging, and high-volume transaction processing. Hard disk drives and tape drives supporting the FC-AL interface are now available from most of the world's computer system manufacturers.

The Fibre Channel protocol identifies devices (e.g. disk drives, tape drives, etc.) using a convention referred to as World Wide Names (WWN). This is similar in concept to network interfaces, such as provided for Ethernet and Token Ring systems which are assigned unique Media Access Control (MAC) addresses. Each Fibre Channel device has a unique World Wide Name such that no two devices in the world should have the same WWN.

Storage automation products, such as the IBM 3584 Ultra Scalable Tape Library, provided by International Business Machines, the assignee of the present invention, may provide one or more Fibre Channel communications interfaces. In addition, the data storage drives included in the library may also provide Fibre Channel communications interfaces. An example of a data storage drive that is used to store and retrieve data with respect to magnetic tape is the IBM TotalStorage® Enterprise Tape Drive 3592 manufactured by IBM Corporation. Tape drives are typically used in combination with an automated data storage library. For example, the IBM TotalStorage® Enterprise Tape Library 3494 manufactured by IBM Corporation is an automated data storage library that may include one or more tape drives and data storage media for storing data with respect to the tape drives.

Service of the library becomes a problem when the library component that provides the Fibre Channel connection is replaced, or when one of the Fibre Channel drives in the library is replaced. This is because those Fibre Channel components each have a unique World Wide Name and when replaced, the replacement components (drives, storage media, etc) will have a completely different World Wide Name. Host systems typically configure their Fibre Channel devices at power-on and they will require a reboot or re-initialization of host software to recognize any devices that have been replaced.

That is, the problem in some cases is solved by a reboot or re-initialization of any affected host systems. This is a real problem for customers that expect a minimum of downtime. Thus, it is a perceived problem presently that when a Fibre Channel component is replaced in the library, there is experienced a customer down-time. It would thus be highly desirable to provide a system and methodology for eliminating customer down-time whenever a Fibre Channel component is replaced in the library.

One solution that addresses the replacement of drives in library storage products is described in U.S. Patent Application #20030065684A1, by Goodman et. al., entitled “System and Method for Logically Assigning Unique Names to Devices in a Storage System”. The system and method described in the Goodman reference is applicable for assigning unique World Wide Names to library storage products having removable or fixed media storage devices, or existing library storage products to be provisioned with Fibre Channel interface connections. Because each World Wide Name is assigned in a one-to-one correspondence with a device position in the library it is not possible to allow devices to occupy any new or different position in the library while retaining the same unique World Wide Name. This limitation is a problem for library storage products having removable storage devices that may occupy any one of a plurality of storage cells. For example, to implement floating home cells in a robotic library, as described in U.S. Pat. No. 4,945,428, the World Wide Name assigned to each removable storage device would have to change each time the removable storage device is moved to a different storage cell. This becomes a more difficult problem to manage as the quantity of removable storage devices increases as libraries are expanded to increase storage capacity. Also, if removable storage devices are exchanged between libraries then the World Wide Name would have to be reassigned based on the position inside of the library where the media will finally reside. In addition, when a removable storage device fails, it is disadvantageous to assign a World Wide Name to the replacement removable storage device that is based upon the position of the failed removable storage device because it may be advantageous for the replacement removable storage device to occupy a different position. Therefore there is a need to improve the management of removable storage devices in storage automation products.

### SUMMARY OF THE INVENTION

Broadly defined, the present invention provides a system and a method for managing removable storage media that are identified by persistent worldwide names. The present invention enhances storage area network (SAN) storage management by preserving the persistent worldwide names assigned to removable storage media when it is necessary to replace the removable storage media.

In method form, exemplary embodiments include a method for managing removable storage media, comprising the steps of: determining that a first removable storage media identified by a persistent worldwide name needs to be replaced, wherein data is stored on the first removable storage media; creating a copy of the data on a second removable storage media; and assigning the persistent worldwide name to the second removable storage media.

In system embodiments the present invention provides a system for managing removable storage media comprising: a first removable storage media for storing data; a persistent worldwide name associated with the a first removable storage media; a second removable storage media; a processor coupled to the first removable storage media and coupled to the second removable storage media, wherein the processor creates a copy of the data on the second removable storage media and assigns the persistent worldwide name to the second removable media.

It will be appreciated by those skilled in the art that although the following detailed description will proceed with reference being made to preferred embodiments and methods of use, the present invention is not intended to be limited to these preferred embodiments and methods of use. Rather, the present invention is intended to be limited only as set forth in the accompanying claims.

For a more detailed understanding of the present invention, reference may be made to the following detailed description taken in conjunction with the accompanying drawings.

### BRIEF DESCRIPTION OF THE DRAWINGS

FIG. 1 is a block diagram that illustrates aspects of an exemplary storage area network (SAN).

FIG. 2 is a block diagram of a library controller which may implement the method of the present invention.

FIG. 3 illustrates an automated data storage library comprising a left hand service bay, multiple storage frames and a right hand service bay.

FIG. 4 illustrates a configuration of the automated data storage library of FIG. 3.

FIG. 5 illustrates an embodiment of an automated data storage library which employs a distributed system of processor nodes.

FIG. 6 illustrates a front and rear view of a data storage drive mounted in a drive canister.

FIG. 7 illustrates a docking station which accepts a removable media.

FIG. 8 illustrates removable media for storage of data.

FIG. 9 is a flowchart flow chart showing the method of the present invention.

FIG. 10 illustrates a RAID of removable media for the storage of data and rebuilding of lost data.

### DETAILED DESCRIPTION OF THE PREFERRED EMBODIMENTS

This invention is described in preferred embodiments in the following description. The preferred embodiments are described with reference to the Figures. While this invention is described in conjunction with the preferred embodiments, it will be appreciated by those skilled in the art that it is intended to cover alternatives, modifications, and equivalents as may be included within the spirit and scope of the invention as defined by the appended claims.

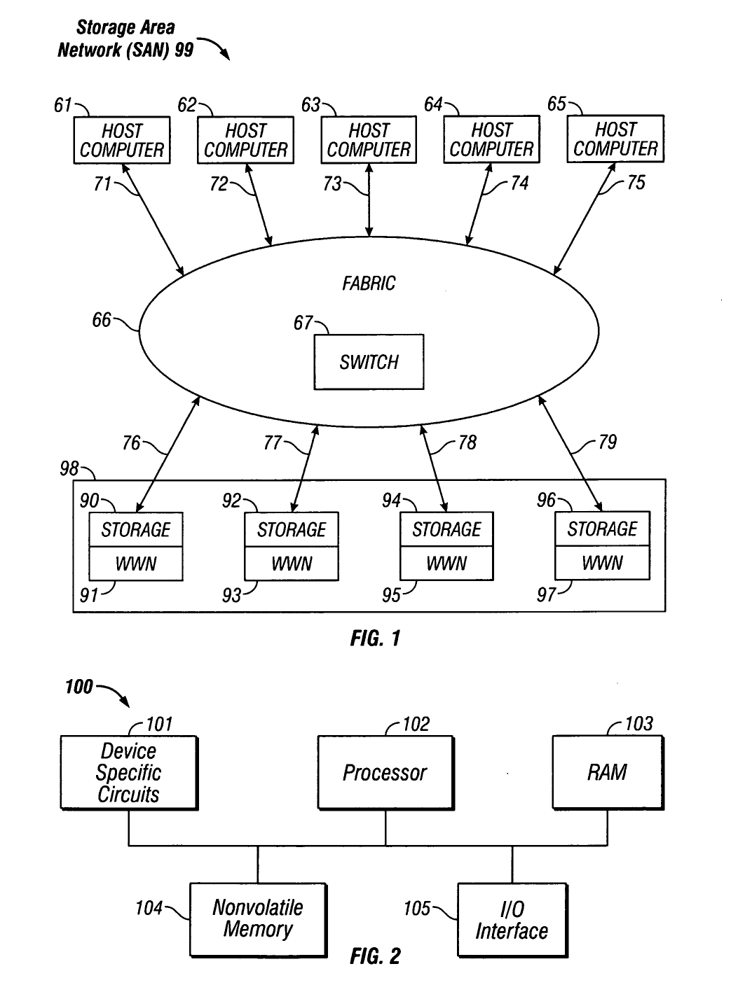

Referring to FIG. 1, there is shown a block diagram that illustrates aspects of an exemplary SAN 99, according to one embodiment of the present invention. In a preferred embodiment, SAN 99 is designed as a switched-access-network, wherein one of more FC switches 67 are used to create FC switching fabric 66. In one embodiment, SAN 99 is implemented using Small Computer Systems Interface (SCSI) protocol running over a Fibre Channel (FC) physical layer. SAN 99 could be implemented over other protocols, such as Infiniband, FICON, TCP/IP, Ethernet, Gigabit Ethernet, or iSCSI. Critical to the data flow in SAN 99, is that switches 67 have the addresses of both the hosts 61-65 and storage 90, 92, 94, and 96. These addresses are called persistent worldwide names, so that wherever the storage 90, 92, 94, and 96 are physically placed, each can be logically accessed transparently by SAN 99 via persistent worldwide names 91, 93, 95, and 97 respectively. A persistent worldwide name is typically a plurality of alpha-numeric characters and each storage component has a unique persistent worldwide name. Herein, persistent worldwide name and world wide name (WWN) are used interchangeably to refer to the same name.

Host computers 61-65 are connected across I/O interfaces 71-75 respectively to fabric 66. I/O interfaces 71-75 may be any type of I/O interface; for example, a FC loop, a direct attachment to fabric 66 or one or more signal lines used by host computers 71-75 to transfer information respectively to and from fabric 66. Fabric 66 includes, for example, one or more FC switches 67 used to connect two or more computer networks. In one embodiment, FC switch 67 is a conventional router switch.

Switch 67 interconnects host computers 61-65 to storage 90, 92, 94, and 96 across respective I/O interfaces 76-79. I/O interfaces 76-79 may be any type of I/O interface, for example, a Fibre Channel, Infiniband, Gigabit Ethernet, Ethernet, TCP/IP, iSCSI, SCSI I/O interface or one or more signal lines used by FC switch 67 to transfer information respectfully to and from storage 90, 92, 94, and 96. In the example shown in FIG. 1, storage 90, 92, 94, and 96 are stored within automated storage library 98.

An automated data storage library typically comprises one or more controllers to direct the operation of the library. The controller may take many different forms and may comprise an embedded system, a distributed control system, a personal computer, workstation, etc. FIG. 2 shows a typical library controller 100 with a processor 102, RAM (Random Access Memory) 103, nonvolatile memory 104, device specific circuits 101, and I/O interface 105. Alternatively, the RAM 103 and/or nonvolatile memory 104 may be contained in the processor 102 as could the device specific circuits 101 and I/O interface 105. Processor 102 may comprise an off the shelf microprocessor, custom processor, FPGA (Field Programmable Gate Array), ASIC (Application Specific Integrated Circuit), discrete logic, etc. RAM (Random Access Memory) 103 is typically used to hold variable data, stack data, executable instructions, etc. The nonvolatile memory 104 may comprise any type of nonvolatile memory such as EEPROM (Electrically Erasable Programmable Read Only Memory), flash PROM (Programmable Read Only Memory), battery backup RAM, hard disk drive, etc. The nonvolatile memory 104 is typically used to hold the executable firmware and any nonvolatile data. I/O interface 105 comprises a communication interface that allows processor 102 to communicate with devices external to the controller. Examples of I/O interface 105 may comprise serial interfaces such as RS-232 or USB (Universal Serial Bus), SCSI (Small Computer Systems Interface), Fibre Channel, etc. In addition, I/O interface 105 may comprise a wireless interface such as RF or Infrared. The device specific circuits 101 provide additional hardware to enable the controller 100 to perform unique functions such as motor control of a cartridge gripper, etc. Device specific circuits 101 may comprise electronics that provide Pulse Width Modulation (PWM) control, Analog to Digital Conversion (ADC), Digital to Analog Conversion (DAC), etc. In addition, all or part of the device specific circuits 101 may reside outside controller 100.

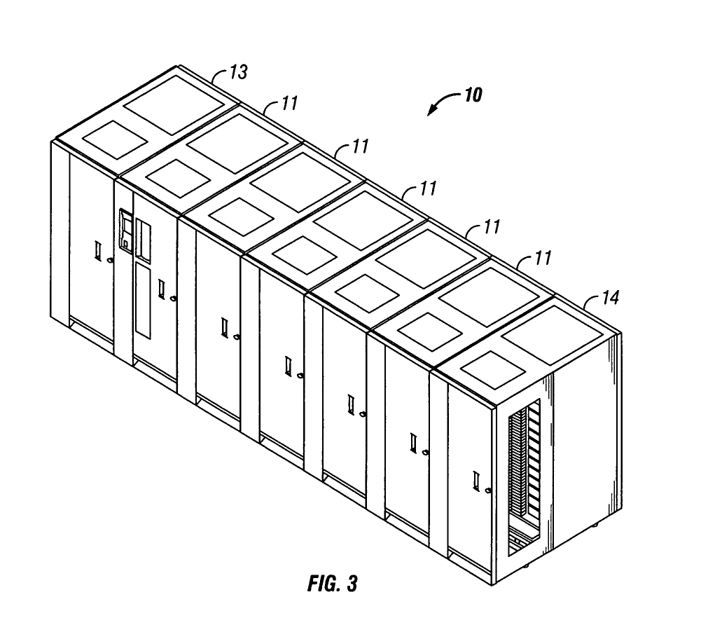

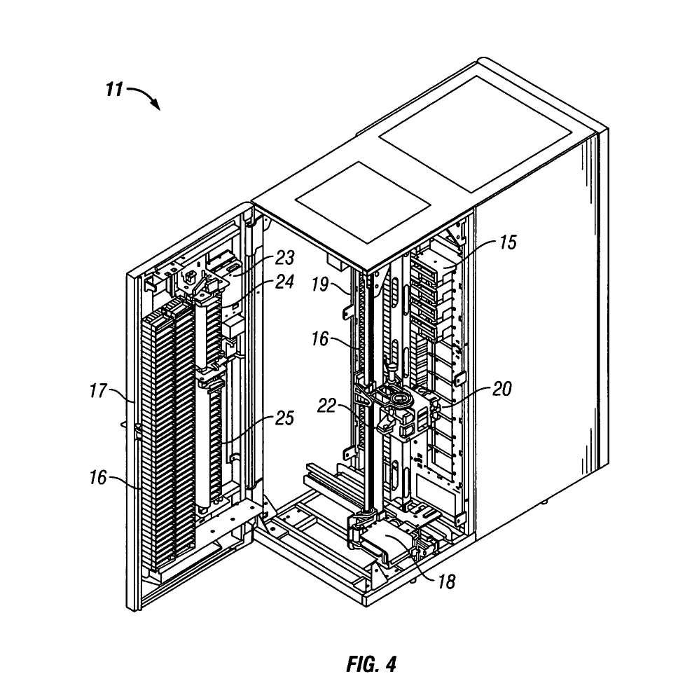

FIG. 3 illustrates an automated data storage library 10 with left hand service bay 13, one or more storage frames 11, and right hand service bay 14. As will be discussed, a frame may comprise an expansion component of the library. Frames may be added or removed to expand or reduce the size and/or functionality of the library. Frames may comprise storage shelves, drives, import/export stations, accessors, operator panels, etc. FIG. 4 shows an example of a storage frame 11, which also is the minimum configuration of the library 10 in FIG. 3. In this minimum configuration, there is no redundant accessor or service bay. The library is arranged for accessing data storage media (not shown) in response to commands from at least one external host system (not shown), and comprises a plurality of storage shelves 16, on front wall 17 and rear wall 19, for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18. As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or reading system, such as a smart card reader or similar system, mounted on the gripper 20, to “read” or “write” identifying information about the data storage media, for example, to a cartridge memory.

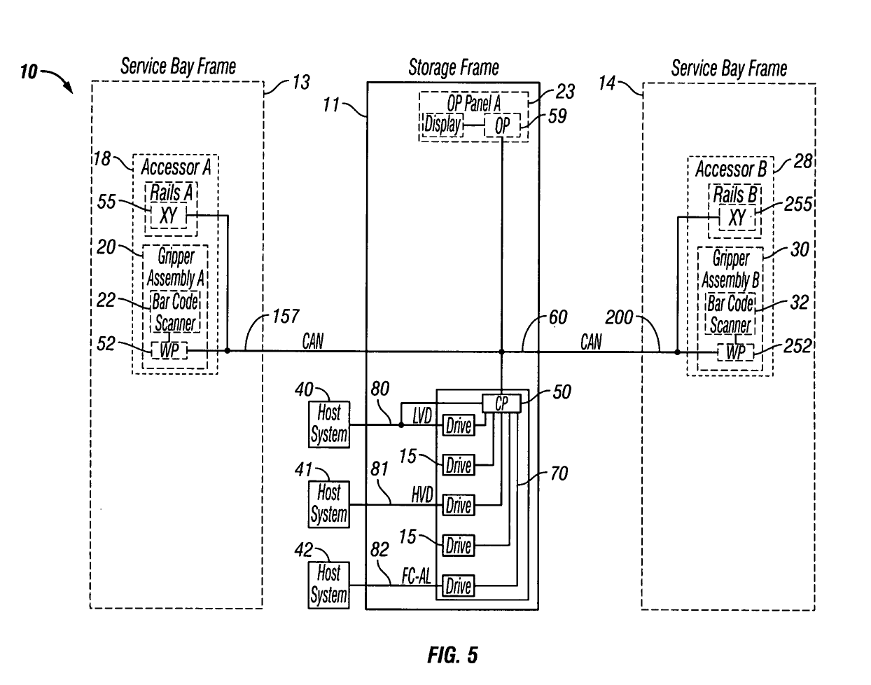

FIG. 5 illustrates an embodiment of an automated data storage library 10 of FIGS. 3 and 4, which employs a distributed system of modules with a plurality of processor nodes. An example of an automated data storage library which may implement the present invention is the IBM 3584 UltraScalable Tape Library. While the library 10 has been described as a distributed control system, this invention applies equally to libraries that incorporate other control configurations such as one or more library controllers that are not distributed. The library of FIG. 5 comprises one or more storage frames 11, a left hand service bay 13 and a right hand service bay 14.

The left hand service bay 13 is shown with a first accessor 18. As discussed above, the first accessor 18 comprises a gripper assembly 20 and may include a reading system 22 to “read” or “write” identifying information about the data storage media, for example, to a cartridge memory. The right hand service bay 14 is shown with a second accessor 28. The second accessor 28 comprises a gripper assembly 30 and may include a reading system 32 to “read” or “write” identifying information about the data storage media, for example, to a cartridge memory. In the event of a failure or other unavailability of the first accessor 18, or its gripper 20, etc., the second accessor 28 may perform all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14. In addition, the present invention may operate with fewer or more than two accessors.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41, 42 or for example, hosts 61-65 shown in FIG. 1. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18 and that is coupled to the communication processor node 50 via a network 60, 157. A second work processor node 252 that may be located at second accessor 28 and that is coupled to the communication processor node 50 via a network 60, 200 may also be provided. Each work processor node may respond to received commands that are broadcast to the work processor nodes from any communication processor node, and the work processor node may also direct the operation of first accessor 18, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor node 52, and the XY processor node 55.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the host(s) and with the data storage drives. In the example of FIG. 5, host connections 80 and 81 are SCSI busses. Bus 82 comprises an example of a Fibre Channel-Arbitrated Loop which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

In FIG. 5 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

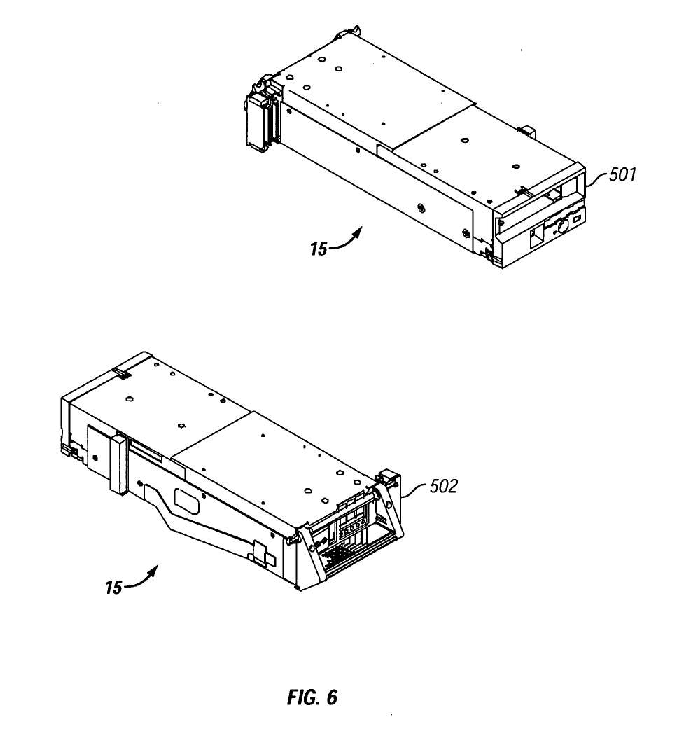

FIG. 6 shows a view of the front 501 and rear 502 of drive 15. In this example, drive 15 is a removable media LTO (Linear Tape Open) tape drive mounted in a drive canister. The drive canister may comprise a housing to hold drive 15, mounting means to attach drive 15 to the drive canister, electrical components, interface cables, interface connectors, etc. The data storage drive of this invention may comprise any removable media drive such as magnetic or optical tape drives, magnetic or optical disk drives, electronic media drives, or any other removable media drive as is known in the art.

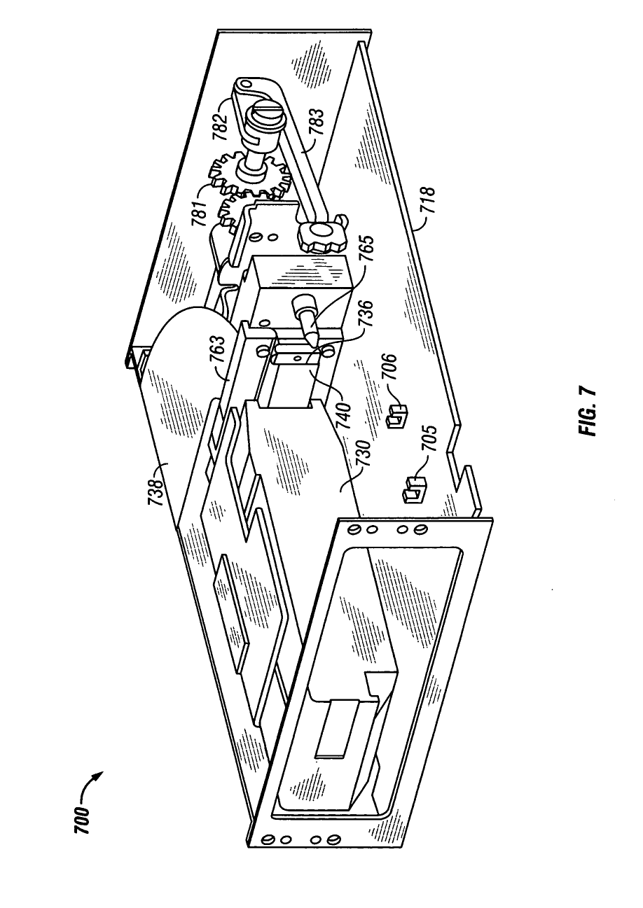

The present invention may be used for any type of removable storage media, for example, magnetic tape media, optical media, hard disk drive media, etc. Herein the descriptors removable storage media, removable media cartridge, and removable media may be used interchangeably to refer to removable storage media. In the preferred embodiment and with reference to FIG. 7, drive 15 is implemented by docking station apparatus 700. Docking station apparatus 700 accepts removable storage media 730 with the rotation of bell crank 782 by gear train 781 which pulls the compliant links 783 toward the rear of cartridge docking station apparatus 700. This motion of compliant link 783 pulls removable media cartridge 730 normal to exposed electrical connections 740 of flexible cable 738, which rest on flexible substrate 736. First, the alignment pin 765 engages a corresponding hole (not shown) in removable media cartridge 730 to orient the removable media cartridge 730 and gradually laterally align a corresponding connector on removable media cartridge 730 with exposed electrical connections 740. This action establishes power to removable media cartridge 730 and bi-directional communication between removable media cartridge 730 and docking station 700. Flexible substrate 736 is supported by stiff substrate 763.

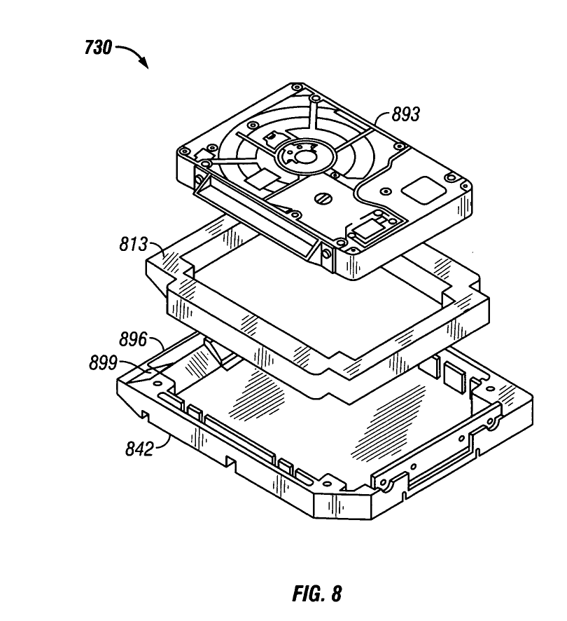

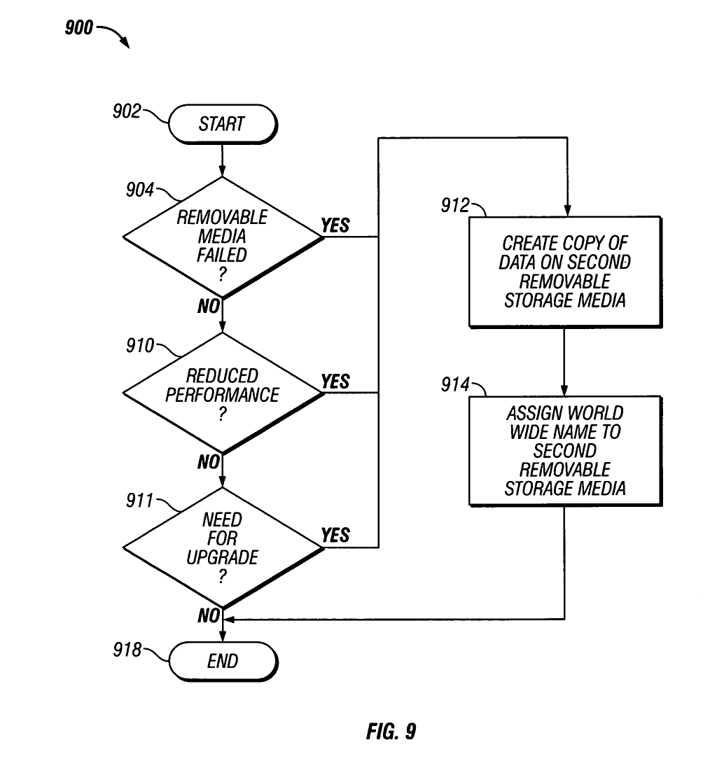

The presence of removable media 730 is detected in docking station 700 via sensor 706. RF antenna 705 communicates with cartridge memory 899 of FIG. 8. RF antenna 705 may both read information from and write information to cartridge memory 899. RF antenna 705 and sensor 706 are mounted on printed circuit board 718. An exemplary cartridge memory is described in ECMA-319 (European Computer Manufacturers Association) “Data Interchange on 12,7 mm 384-Track Magnetic Tape Cartridges—Ultrium-1 Format,” Annex D entitled LTO Cartridge Memory, pages 95-115.

Referring to FIG. 8, a removable media cartridge 730 is provided having a cartridge shell 896 for storing a device, such as a data storage device. Such portable cartridges have been employed for the storage of data on a length of magnetic tape. In the preferred embodiment, an encased, self-contained magnetic disk drive assembly 893 may be mounted in such a cartridge. As discussed above, such removable media cartridges may be stored in automated data storage library 10, or handled manually. In handling the cartridges, robotic accessors, of automated data storage libraries occasionally drop a cartridge, or misplace a cartridge such that it is handled roughly, and manual handling is also likely to result in an occasional dropped or roughly handled cartridge. However, the typical data storage drive is not designed to accommodate that level of rough handling. As an example, a magnetic disk drive assembly that is available for use with a portable computer, is typically encased to prevent debris from getting into the assembly, and is preferably self-contained and operational, comprising both the necessary mechanical and electronic components. In this context, the assembly comprises at least one rotatable disk, a motor for rotating the disk(s), at least one head, an actuator and servo system for seeking and tracking, and addressing, motor control, and data handling electronics for reading and writing data, and for communicating at the data transfer interface, for example, employing an industry standard format, such as IDE, ATA, SCSI, or PCI.

The height dimension, comprising the stack of heads, one or more disks, and the disk motor, is typically the most critical, such that there is no room for a support structure for the cover over the disks and heads. Any force exerted on the cover has the possibility of causing the cover to deflect inwardly such that it may contact a head or disk, destroying or causing damage to the disk drive. A breathing hole is typically provided to prevent variations in atmospheric pressure from deflecting to cover. An organic filter and a desiccant may be provided on the inside of the hole for filtering debris and contaminates. As the result, although shock absorption is necessary, the cover comprises a sensitive surface which is unable to support a shock absorbing structure. Similarly, the typical magnetic disk drive assembly has a PCB (printed circuit board) at the bottom surface, which also comprises a sensitive surface that is unable to support a shock absorbing structure without deflecting and damaging the drive. Further, such sensitive surfaces may be unable to come into contact with a shock absorbing structure without causing damage to the disk drive, and certainly would be unable to come into contact with the cartridge shell, for example, through slippage within the shock mount, without causing damage to the disk drive.

FIG. 8 comprises an exploded view of an example of removable media cartridge 730, and contains, as an example, an encased, self-contained and operational magnetic data storage drive 893. An example of an encased, self contained, magnetic data storage drive of the desired form factor to fit within the cartridge shell 896 comprises a 2.5 inch series of magnetic data storage drives. FIG. 8 illustrates the bottom half 842 of the cartridge shell 896. Optional shock absorbing foam 813 or another shock absorbing material may be used to protect drive 893 from shock and vibration, such as being accidentally dropped by an accessor of automated data storage library 10.

Also shown in FIG. 8 is cartridge memory 899. Cartridge memory 899 may be aligned at any angle, so that the contents of cartridge memory 899 may be read or written by sensor 705 of docking station 700 of FIG. 7, or equally read or written by a similar sensor on an accessor of automated data storage library 10. Although the preferred embodiment is described with reference to automated data storage library 10, removable media cartridge 730 and docking station 700, the present invention is intended to apply to other types of data storage drives, removable media, removable media cartridges, without limitation. Also alternative data storage systems other than automated data storage library 10, for example, a personal computer, computing device, etc. may be used to implement the present invention.

Library controller 100 may comprise a dedicated controller of a prior art library or it may comprise a processor node of a distributed control library, such as the library of FIG. 5. For example, in FIG. 5, library controller 100 comprises communication processor (CP) node 50, work processor (WP) node 52, XY motion processor node 55, etc. In addition, library controller 100 may comprise more than one processor node, such as a distributed control library that employs multiple processor nodes to accomplish library functionality. Herein, library controller may comprise a single controller or multiple controllers or processors.

The method of the present invention can be better understood by referring to flowchart 900. The process starts at step 902 and flows to decision step 904. At step 904, the removable media cartridge 730 that is identified by a persistent worldwide name is examined to determine if removable media cartridge 730 has failed and needs to be replaced. The persistent worldwide name is associated with removable media cartridge 730 to provide identification of removable media cartridge 730 regardless of the physical location of removable media cartridge. Examples of a failure of removable media cartridge 730 are when the data stored on removable media cartridge 730 cannot be retrieved or removable media cartridge 730 does not respond to communications. Other modes of failure of removable media cartridge 730 are removable media cartridge 730 does not respond to power-on commands, does not respond to “wake up” from a “sleep mode” commands, has head stiction which prevents disk media from spinning up to speed or has a catastrophic head crash which jams the head and its actuator against the disk media and prevents the disk from spinning. Removable media cartridge 730 may be accidentally dropped and/or damaged by an accessor resulting in damage to removable media cartridge 730. An additional failure mode is a hardware error detected via a unit check status with sense data from the storage device 893 in removable media 730.

The failure of removable media cartridge 730 may be detected by a failure detection apparatus, for example, by library controller 100 using one or more of the associated processors described above. Alternatively other processors or circuits associated with automated data storage library 10, docking station 700, drive 15 or other processors with access or coupled to removable media cartridge 730 may be used to detect a failure. Additional failure detection may be generated from hard disk drive 893. Hard disk drive 893 (FIG. 8) typically has a Self-Monitoring Analysis and Reporting Technology (S.M.A.R.T.), so that hard disk drive 893 can identify operational problems and report these problems to library controller 100. If at step 904, a failure of removable media cartridge 730 is detected, then the process flows to step 912 to create a copy of the data that was stored on removable media cartridge 730 for storage on a second removable storage media. The copy of the data may be created by different methods depending upon the severity of the failure of the removable storage media and is explained below with reference to step 912. If at step 904, a failure of removable media cartridge 730 is not detected, then the process flows to step 910.

Step 910 is a predictive failure step, where the performance of removable media cartridge 730 is examined to determine if the performance is acceptable. Different criterion may be used to determine the performance of removable media cartridge 730, without limitation, with respect to the present invention. For example, the number of errors that have occurred during input/output (I/O) operations with respect to storing or retrieving data on removable media cartridge 730 may be determined to compare to a user-defined error threshold to determine if removable media cartridge 730 needs to be replaced because of reduced performance. If the number of errors is greater than or equal to the user-defined error threshold, then a reduced performance is detected and the process flows to step 912 where a copy of the data from removable media cartridge 730, is created on a second removable media. The copy of the data may be created by different methods depending upon the severity of the reduced performance of the removable storage (explained below with reference to step 912). The number of errors that have occurred during I/O with respect to removable media cartridge 730 may be detected by a performance detection apparatus, for example, by library controller 100 using one or more of the associated processors described above. Alternatively other processors or circuits associated with automated data storage library 10, docking station 700, drive 15 or other processors with access or coupled to removable media cartridge 730 may be used to detect the number of errors or other indications of reduced performance. If the errors are less than the error threshold, then removable media cartridge 730 has an acceptable error rate indicating that removable media cartridge 730 does not have reduced performance and the process flows to step 911. Alternatively, the performance of removable media cartridge 730 may be considered to be unacceptable if for example, some component of removable media cartridge 730, for example, cartridge memory 899 is failing, or has completely failed due to electrostatic discharge, has reduced capacity due to radiation damage of part of the memory, has consistent repeated load failures, or has reduced performance.

At step 911 removable media cartridge 730 is examined to determine if it is necessary to replace removable media cartridge 730 to upgrade removable media cartridge 730 to a different removable storage media. There may be many different reasons why it is necessary to replace removable media cartridge 730 for an upgrade, and the present invention is applicable without limitation, regardless of the reason for an upgrade. For example, removable media cartridge 730 may have reduced storage capacity compared to a newer removable storage media, a different type of data storage drive may be used that requires a different removable storage media, for example, to migrate from magnetic tape storage to hard disk storage. Also, another component, for example, cartridge memory 899 in removable media cartridge 730 may need to be upgraded or a new physical configuration of the removable media cartridge 730 may necessitate a need for an upgrade. In addition, automated data storage library 10 may be expanded to increase the storage capacity and this may require an upgrade for the removable media cartridge 730. Another reason for an upgrade is that a time limit and/or usage limit threshold may be placed on removable media cartridge 730, and removable media cartridge 730 would need to be upgraded or replaced once either of these thresholds are violated. Regardless of the reason, if the need for an upgrade is detected and it is necessary to replace removable media cartridge 730 to upgrade removable media cartridge 730 to a different removable storage media, then the process flows to step 912 where a copy of the data from removable media cartridge 730, is created on a second removable media. The copy of the data may be created by different methods depending upon differences or similarities between removable media cartridge 730 and the replacement removable storage media (explained below with reference to step 912. The need to replace removable media cartridge 730 to upgrade removable media cartridge 730 to a different removable storage media may be detected by an upgrade detection apparatus, for example, by library controller 100 using one or more of the associated processors described above. Alternatively other processors or circuits associated with automated data storage library 10, docking station 700, drive 15 or other processors with access or coupled to removable media cartridge 730 may be used to detect the need to upgrade. Alternatively an operator may use operator panel 23 or other user interface, such as a web-based interface, which allows a user to interact with the library to direct library controller 100 to replace removable media cartridge 730 to upgrade removable media cartridge 730 to a different removable storage media. If at step 911 it is determined that removable media cartridge 730 does not need to be upgraded, the process flows to step 918 where the process ends.

The process of flowchart 900 may begin anytime during the operation of automated data storage library 10, for example, a timer or other timing device may start the process at a specified interval of time that may vary from seconds to many hours. Alternatively, upon reaching step 918, the process may immediately start again at step 902, resulting in continuous operation. The process of flowchart 900 may be triggered by library controller 100 detecting a failure via a unit check status returned as a result of a command issued by library controller 100.

As described above, step 912 may be entered by a “YES” result from steps 904, 910 or 911. At step 912, a copy of data that exists or that existed prior to a failure on removable media cartridge 730 is created on the second removable storage media. The copy of the data may be created on the second removable storage media by simply copying the data from removable media cartridge 730 to second removable media or other methods may be used, for example, the data may be reconstructed form other sources if necessary.

If step 912 is entered as a result of a “YES” result of step 904, then a portion of the data that was stored on removable media cartridge 730 may be unrecoverable from removable media cartridge 730. If the failed storage was part of a RAID array, for example, RAID 3, 4, or 5, the copy of the data may be created by rebuilding the data from RAID XOR (exclusive or) binary Boolean parity calculations as is known in the art. These XOR calculations may be simple bit-by-bit binary arithmetic addition without carry-over. For example, 0b <XOR>0b=0b, 1b<XOR>0b=1b, 0b <XOR>1b=1b, and finally 1b<XOR>1b=0, where the suffix b indicates the binary number system is used. An example of the calculation of RAID XOR parity and RAID rebuild is now presented for the data 1101b and data 0011b. Data 1101b <XOR> data 0011b results in a parity 1110b. If data 0011b is lost due to a removable media failure, then data 0011b may be rebuilt by the XOR between the remaining data 1110b and the previously calculated parity 1110b that is stored elsewhere, for example, on other removable media. Data 1101b <XOR> parity 1110b results in the formerly lost but now rebuilt data 0011b. Thus, RAID levels 3, 4, and 5 allow the rebuilding of data which can be lost when one of the component storage members of the RAID fails. This rebuilding may include a data transfer if the storage was part of a RAID 1 mirror. Any of the RAID devices/arrays described herein may be coupled to one or more processors to enable the processor to obtain a copy of the data by RAID parity calculations or other means.

If the data stored on removable media cartridge 730 was previously copied to another storage device to provide a backup copy of the data, for example, another removable storage media, magnetic tape, magnetic disk, optical disk, remote storage device, etc., then the copy of the data may be created on the second removable media by accessing the data stored on the backup storage device to obtain a copy of the data. Alternatively, the copy of the data may be created by reconstruction of the data from one or more sources, for example, parts of the data may be spread across different storage locations. The data may be reconstructed by merging parts of the data from the different storage locations. The creation of the copy of data may be controlled by, for example, library controller 100. Alternatively other processors associated with automated data storage library 10, docking station 700, drive 15 or other processors with access to removable media cartridge 730 may be used to create the copy of the data. The storage devices are coupled to the processor to enable the processor to obtain a copy of the data from one or more storage devices by reconstruction of data.

If step 912 is entered as a result of a “YES” result of step 910 or 911 then the data that was stored on removable media cartridge 730 is most likely recoverable from removable media cartridge 730. The copy of the data may be created by simply reading the data from removable media cartridge 730 and then storing the data on the second removable media. In some cases it may be necessary to rebuild the data as described above, obtain the data from a backup storage device, or a combination of rebuilding some data and obtaining the remainder from backup storage. The data read from removable media cartridge 730 may be temporary stored on, for example, another removable storage media, magnetic tape, magnetic disk, optical disk, remote storage device, etc., before storing the data on the second removable media. Alternatively, one or more docking stations 700, drives 15 or other data storage devices may be used to directly create the copy of the data on the second removable media. As described above, the creation of the copy of data may be controlled by, for example, library controller 100. Alternatively other processors associated with automated data storage library 10, docking station 700, drive 15 or other processors with access to removable media cartridge 730 may be used to create the copy of the data.

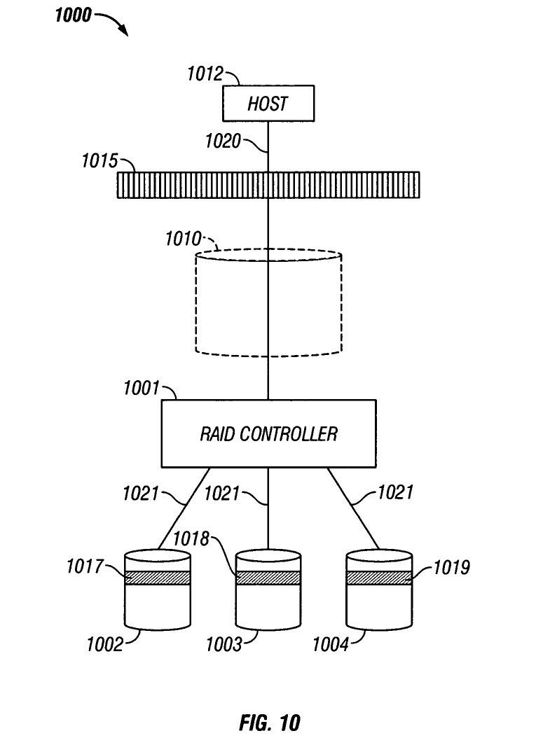

After creating a copy of the data on a second removable media at step 912, the process flows to step 914, where the persistent worldwide name that identified removable media cartridge 730 is assigned to the second removable media that now contains a copy of the data from removable media cartridge 730. The persistent worldwide name may be stored in a memory device associated with second removable media. For example, the persistent worldwide name may be stored in the storage media of second removable media. The storage media of second removable media, may be, for example, the optical storage media for an optical disk, the disk surface of a hard disk drive, magnetic tape of a magnetic tape cartridge, etc. Alternatively a cartridge memory associated with second removable media may be used to store the persistent worldwide name assigned to second removable media. In addition to the storage of the persistent worldwide name, other information from removable media cartridge 730 may be stored in a memory device associated with second removable media. For example, the entire contents of cartridge memory 899 of removable media cartridge 730 may be transferred to the cartridge memory of the second removable media to create a copy of the contents of cartridge memory 899 of the removable media cartridge 730 in a second cartridge memory of the second removable storage media. The contents of the removable media cartridge 730 cartridge memory may need to be rebuilt if necessary to include directory information of the data from removable media cartridge 730, metadata of the data stored in removable media cartridge 730, and the persistent worldwide name of removable media cartridge 730. Metadata are the addresses of the stripes in a RAID. It is within a stripe consisting of segments 1017-1019, shown in FIG. 10, that the actual data and parity is stored within RAID 1000. Thus, the RAID controller 1001 uses the metadata to write the data in stripes, track to locations of the data, and subsequently read the data. Alternatively, the storage of second removable media may be used to store directory information that is obtained from removable media cartridge 730. After all necessary data, directory information, persistent worldwide name information and any new information necessary is stored on second removable media, the persistent worldwide name of the replaced removable media cartridge 730 is removed. The persistent worldwide name of removable media cartridge 730 may be removed, for example, by erasing the contents of the memory device where the persistent worldwide name was stored. An example for cartridge memory 899 is an EEPROM (electrically erasable, programmable, read-only memory). The result is that the replacement removable media storage (second removable media) has the persistent worldwide name of the removable media it is replacing and the old removable media no longer has that persistent worldwide name. Thus, the uniqueness of the persistent worldwide name is preserved and SAN 99 does not have to undergo complicated address changes to absorb the new replacement storage, because the new replacement storage has the same persistent worldwide name as the storage it has replaced. The persistent worldwide name of removable media cartridge 730 is transferred to the second removable media with the result that the second removable media contains all or more of the information stored on and associated with removable media cartridge 730 prior to the replacement of removable media cartridge 730. The entire contents of the removable media cartridge 730 cartridge memory may be erased or overwritten to remove any identification with the persistent worldwide name and to indicate a failure of removable media cartridge 730 if necessary. After execution of step 914, process flows to step 918 to end the procedure.

Referencing steps 912 and 914, it is preferred that the contents of the new cartridge memory are written by the RF antenna 705 of docking station 700. In this preferred embodiment RF antenna 705 performs the function of coupling any processors associated with automated data storage library 10, docking station 700, drive 15 or other components with cartridge memory 899 of removable media cartridge 730 or the second removable media. Alternately, coupling of any processors associated with automated data storage library 10 to a cartridge memory to write or read the contents of the new cartridge memory may be accomplished by an RF antenna or other device associated with bar code scanner 22 or reading system, for either accessor as previously described. In addition, coupling of any processors to a cartridge memory may be accomplished by other means for use with the present invention, without limitation. The RF antenna is preferably a simple inductive loop, and has associated capacitors to form an oscillating inductive-capacitive or “LC” circuit. This RF antenna essentially broadcasts and receives at a specific frequency in radians per second, equal to the reciprocal of the square root of the product of inductance in Henrys times capacitance in Farads, and that is the same frequency at which memory chip 899 is designed to communicate over.

An example of a RAID array device is shown in FIG. 10. RAID array 1000 comprises three removable media 1002-1004. This RAID array may be RAID level 3, 4, or 5 or any other RAID level. A RAID array may contain more removable media, but for simplification, only three removable media are illustrated. RAID array 1000 also has RAID controller 1001 which manages the data on removable media 1002-1004. RAID controller 1001 presents all physical removable media 1002-1004 as one logical device 1010 to host 1012. The host 1010 and RAID controller 1001 are coulpled and communicate across I/O interface 1020, which may be SCSI, iSCSI, Fibre Channel, SSA, Infiniband, Gigabit Ethernet, Ethernet, TCP/IP, etc. RAID controller 1001 and removable media 1002-1004 communicate across I/O interface 1021 which may be SCSI, iSCSI, Fibre Channel, SSA, Infiniband, Gigabit Ethernet, Ethernet, TCP/IP, etc. Data 1015 and associated parity are written by the host 1012 to logical device 1010. Data 1015 is spread across removable media 1002-1004 in plurality of stripes. An example stripe is shown in FIG. 10, consisting of data segments 1017-1018 and parity 1019. RAID controller 1001 calculates parity 1019 in the same manner as the previously described XOR calculations. In FIG. 10, parity 1019 is written to removable media 1004. The removeable media which hold parity for a given stripe, such as stripe 1017-1019, may alternate within the RAID for RAID level 5, or parity may be written to one and only one removeable media for RAID levels 3 and 4. Rebuilding is also done with the XOR calculation, as previously described. For example, if data 1018 were lost due to failure of removeable media 1003, this data could be rebuilt by the XOR of remaining data 1017 on removeable media 1002 and parity 1019 on removeable media 1004.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Obviously many modifications and variations are possible in view of the above teachings.

The invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium, hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A method for managing removable storage media, comprising:
determining that a first removable storage media on which data is stored needs to be replaced, said first removable storage media is identified by a persistent worldwide name;
creating a copy of said data on a second removable storage media;
assigning said persistent worldwide name to said second removable storage media.

2. The method of claim 1, further comprising:
removing said persistent worldwide name from said first removable storage media.

3. The method of claim 1, wherein the determining step further comprises:
detecting a failure of said first removable storage media.

4. The method of claim 1, wherein the determining step further comprises:
detecting a reduced performance of said first removable storage media.

5. The method of claim 1, further comprising:
using a user interface to direct a library controller to replace said first removable storage media.

6. The method of claim 1, wherein the determining step further comprises:
detecting a need for an upgrade of said first removable storage media.

7. The method of claim 1, wherein the creating step further comprises:
obtaining said copy of said data by RAID parity calculations.

8. The method of claim 1, wherein the creating step further comprises:
obtaining said copy of said data from a backup copy of said data.

9. The method of claim 1, wherein the creating step further comprises:
obtaining said copy of said data by reconstruction of said data from one or more sources.

10. The method of claim 1, further comprising:
storing said persistent worldwide name in a cartridge memory.

11. The method of claim 1, further comprising:
storing said persistent worldwide name in a storage media of said second removable media.

12. The method of claim 1, further comprising:
creating a copy of a contents of a first cartridge memory of said first removable storage media in a second cartridge memory of said second removable storage media.

13. A system for managing removable storage media comprising:
a first removable storage media for storing data;
a persistent worldwide name associated with said a first removable storage media;
a second removable storage media;
a processor coupled to said first removable storage media and coupled to said second removable storage media, wherein said processor creates a copy of said data on said second removable storage media and assigns said persistent worldwide name to said second removable media.

14. The system of claim 13, wherein said processor removes said persistent worldwide name from said first removable storage media.

15. The system of claim 13, further comprising:
a failure detection apparatus for detecting a failure of said first removable storage media.

16. The system of claim 13, further comprising:
a performance detection apparatus for detecting a performance of said first removable storage media.

17. The system of claim 13, further comprising:
an upgrade detection apparatus for detecting a need for an upgrade of said first removable storage media.

18. The system of claim 13, further comprising:
a library controller; and
a user interface coupled to said library controller, wherein said user interface is used for inputting information to direct said library controller to replace said first removable storage media.

19. The system of claim 13, further comprising:
At least one RAID device coupled to said processor, wherein said processor obtains said copy of said data by RAID parity calculations.

20. The system of claim 13, further comprising:
A backup storage device coupled to said processor, wherein said processor obtains said copy of said data from said backup storage device.

21. The system of claim 13, further comprising:
one or more storage devices coupled to said processor, wherein said processor obtains said copy of said data from said one or more storage devices by reconstruction of data from said one or more sources.

22. The system of claim 13, further comprising:
a cartridge memory associated with said second removable storage media and coupled to said processor, wherein said processor stores said persistent worldwide name in said cartridge memory.

23. The system of claim 13, further comprising:
A storage media associated with said second removable storage media and coupled to said processor, wherein said processor stores said persistent worldwide name in said storage media.

24. An automated data storage library comprising a system for managing removable storage media comprising:
a first removable storage media for storing data;
a persistent worldwide name associated with said first removable storage media;
a second removable storage media;
a processor coupled to said first removable storage media and coupled to said second removable storage media, wherein said processor creates a copy of said data on said second removable storage media and assigns said persistent worldwide name to said second removable media.

25. An article of manufacture comprising a data storage medium tangibly embodying a program of machine-readable instructions executable by a digital processing apparatus to perform method steps for managing removable storage media, comprising:
determining that a first removable storage media identified by a persistent worldwide name needs to be replaced, wherein data is stored on said first removable storage media;
creating a copy of said data on a second removable storage media;
assigning said persistent worldwide name to said second removable storage media.

26. The article of manufacture of claim 25, wherein said method further comprises:
removing said persistent worldwide name from said first removable storage media.

27. The article of manufacture of claim 25, wherein the determining step further comprises:
detecting a failure of said first removable storage media.

28. The article of manufacture of claim 25, wherein the determining step further comprises:
detecting a reduced performance of said first removable storage media.

29. The article of manufacture of claim 25, further comprising:
using a user interface to direct a library controller to replace said first removable storage media.

30. The article of manufacture of claim 25, wherein the determining step further comprises:
detecting a need for an upgrade of said first removable storage media.

31. The article of manufacture of claim 25, wherein the creating step further comprises:
obtaining said copy of said data by RAID parity calculations.

32. The article of manufacture of claim 25, wherein the creating step further comprises:
obtaining said copy of said data from a backup copy of said data.

33. The article of manufacture of claim 25, wherein the creating step further comprises:
obtaining said copy of said data by reconstruction of said data from one or more sources.

34. The article of manufacture of claim 25, wherein said method further comprises:
storing said persistent worldwide name in a cartridge memory.

35. The article of manufacture of claim 25, wherein said method further comprises:
storing said persistent worldwide name in a storage media of said second removable media.
